(19) United States
(12) Patent Application Publication
(10) Pub. No.: US 2023/0408887 A1
(43) Pub. Date: Dec. 21, 2023

(54) CAMERA MODULE

(71) Applicant: SAMSUNG ELECTRO-MECHANICS CO., LTD., Suwon-si (KR)

(72) Inventors: Ahhyeon IM, Suwon-si (KR); Byungwoo KANG, Suwon-si (KR)

(73) Assignee: SAMSUNG ELECTRO-MECHANICS CO., LTD., Suwon-si (KR)

(21) Appl. No.: 18/097,734

(22) Filed: Jan. 17, 2023

(30) Foreign Application Priority Data
Jun. 20, 2022 (KR) 10-2022-0074819

(51) Int. Cl. G03B 5/00; G03B 17/12; G03B 17/17; H04N 23/55; H04N 23/51

(52) U.S. Cl. CPC G03B 5/00; G03B 17/12; G03B 17/17; H04N 23/55; H04N 23/51; G03B 2205/0053

(57) ABSTRACT

A camera module including: a housing defining an inner space; a movable holder disposed in the inner space and supported on an inner wall of the housing; a folded module including a reflective member mounted on the movable holder, the reflective member changing a path by reflecting light incident from the outside; a lens module including a plurality of lenses arranged in an optical axis direction to pass the light reflected from the reflective member; a lens barrel disposed at a rear side of the folded module in the inner space to move in the optical axis direction; and a magnet stopper including a stationary magnet stopper member disposed in the housing, and a moving magnet stopper member disposed in the lens module to face the stationary magnet stopper member in the optical axis direction to generate a repulsive force to each other.

### CROSS-REFERENCE TO RELATED APPLICATION

This application claims priority to and the benefit under 35 USC 119(a) of Korean Patent Application No. 10-2022-0074819 filed in the Korean Intellectual Property Office on Jun. 20, 2022, the entire contents of which are incorporated herein by reference for all purposes.

### BACKGROUND

### Field

The following description relates to a camera module.

### Description of the Background

With the remarkable development of information and communication technology and semiconductor technology, supply and use of electronic devices is rapidly increasing. These electronic devices tend to provide various functions by convergence rather than staying in their typical unique domains.

Cameras have been basically adopted in portable electronic devices such as smartphones, tablet PCs, and laptop computers, and an auto focus (AF) function, an image stabilizer (IS) function, and a zoom function are added to the cameras as these portable electronic devices.

The image stabilizer function may include both camera shake compensation and hand shake compensation, and by the image stabilizer function, it is possible to prevent an image of a subject being photographed from vibrating due to unintentional occurrence of hand shake or camera shake by a photographer in a moving or stationary state of the camera.

The auto focus function is a function that enables a clear image to be acquired from an imaging plane of an image sensor by moving a lens positioned in front of the image sensor along an optical axis direction according to a distance from the subject. The auto focus function has been installed in expensive electronic devices, but now it has become an essential feature installed even in low-cost entry-level electronic devices.

In addition, as high performance of a camera module progresses, it is necessary to secure reliability such as reducing an impact between the lens and a counterpart and preventing noise in order to smoothly implement the auto focus function, the image stabilizer function, and the zoom function.

The above information disclosed in this Background section is only for enhancement of understanding of the background of the invention, and therefore it may contain information that does not form the prior art that is already known in this country to a person of ordinary skill in the art.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a camera module includes: a housing defining an inner space; a movable holder disposed in the inner space and supported on an inner wall of the housing; a folded module including a reflective member mounted on the movable holder, the reflective member being configured to change a path by reflecting light incident from the outside; a lens module including a plurality of lenses arranged in an optical axis direction and configured to pass the light reflected from the reflective member; a lens barrel disposed at a rear side of the folded module in the inner space and configured to move in the optical axis direction; and a magnet stopper including a stationary magnet stopper member disposed in the housing, and a moving magnet stopper member disposed in the lens module to face the stationary magnet stopper member in the optical axis direction and configured to generate a repulsive force to each other.

The stationary magnet stopper member may include a stationary magnet stopper member spaced apart from the lens module in front of the lens module in the optical axis direction and a stationary magnet stopper member spaced apart from the lens module in a rear of the lens module in the optical axis direction.

The moving magnet stopper member may include a moving magnet stopper member disposed at a front end along the optical axis direction of the lens module and a moving magnet stopper member disposed at a rear end along the optical axis direction of the lens module.

The lens module may include a groove in a mold structure forming an exterior of the lens barrel, and the moving magnet stopper member may be fixed by being inserted into the groove.

The housing may include a pair of side walls that are parallel to the light incident direction and the optical axis and face each other, and the stationary magnet stopper member may include at least one first pair of stationary magnet stopper members disposed to be respectively adjacent to the pair of side walls and symmetrical based on the optical axis.

The camera module may further include a protruding wall that protrudes from the pair of side walls of the housing toward the inner space, and the stationary magnet stopper member may be fixed to the protruding wall.

The protruding wall may include a groove, and the stationary magnet stopper member may be fixed by being inserted into the groove.

The at least one pair of the stationary magnet stopper members may be spaced apart from the lens module in front of the lens module in the optical axis direction, and at least one second pair of the stationary magnet stopper members may be spaced apart from the lens module in rear of the lens module in the optical axis direction.

The moving magnet stopper member may include a first pair of moving magnet stopper members disposed at a front end along the optical axis direction of the lens module and a second pair of moving magnet stopper members disposed at a front end along the optical axis direction of the lens module.

Each of the first and second pairs of moving magnet stopper members includes moving magnet stopper members fixed to the lens module and disposed at both sides of the lens module to be symmetrical based on the optical axis.

The housing may include a pair of side walls that are parallel to the light incident direction and the optical axis and face each other, the lens module may include a focus adjusting magnet mounted to face the side wall, and the moving magnet stopper member may be the focus adjusting magnet.

The stationary magnet stopper member may include a stationary magnet stopper member spaced apart from the lens module at a front side of the lens module in the optical axis direction and a stationary magnet stopper member spaced apart from the lens module at a rear side of the lens module in the optical axis direction, and the stationary magnet stopper members may face the focus adjusting magnet in the optical axis direction.

In another general aspect, a camera module including: a housing defining an inner space; a folded module including a reflective member that changes a path by reflecting light incident from the outside, and a movable holder on which the reflective member is mounted and disposed in the inner space and supported on an inner wall of the housing to be movable; a lens module including a plurality of lenses aligned in an optical axis direction to pass light reflected from the reflective member, and at least two lens barrels are disposed at a rear side of the folded module in the inner space and configured to be movable in the optical axis direction and in which the plurality of lenses are divided and provided; and a first magnet stopper member disposed in one of the at least two lens barrels, and a second magnet stopper member disposed in the other one of the at least two lens barrels to face the first magnet stopper member in the optical axis direction to generate a repulsive force to each other.

The at least two lens barrels may include: a first lens barrel and a second lens barrel that are sequentially disposed to face each other in the optical axis direction and in which the first magnet stopper member and the second magnet stopper member are mounted, respectively; and the first magnet stopper member may be disposed and mounted close to a surface of the first lens barrel facing the second lens barrel, and the second magnet stopper member may be disposed and mounted close to a surface of the second lens barrel facing the first lens barrel.

A pair of the first magnet stopper members and a pair of the second magnet stopper members may be respectively disposed at both sides of the lens barrel based on the optical axis.

In another general aspect, a camera module includes: a housing defining an inner space; a folded module including a reflective member that changes a path by reflecting light incident from the outside, and a movable holder on which the reflective member is mounted and disposed in the inner space to be supported on an inner wall of the housing to be movable; a lens module including a plurality of lenses arranged in an optical axis direction to pass the light reflected from the reflective member, and a lens barrel disposed at a rear side of the folded module in the inner space and configured to move in the optical axis direction; and a magnet stopper including an unmovable magnet stopper member disposed in the housing, and a movable magnet stopper member disposed in the movable holder to face the unmovable magnet stopper member in the light incident direction and configured to generate a repulsive force to each other.

A pair of the movable magnet stopper members may be disposed at both sides of the reflective member based on the optical axis.

A pair of the unmovable magnet stopper members may be disposed in the housing to respectively face the movable magnet stopper members.

Other features and aspects will be apparent from the following detailed description, the drawings, and the claims.

### BRIEF DESCRIPTION OF THE DRAWINGS

FIG. 1 illustrates a perspective view of a camera module according to an example.

FIG. 2 illustrates a schematically exploded perspective view of the camera module illustrated in FIG. 1.

FIG. 3 illustrates a perspective view of a housing and a lens module of the camera module illustrated in FIG. 1.

FIG. 4 illustrates a top plan view in which the inside of the camera module illustrated in FIG. 1 is exposed by removing a cover thereof.

FIG. 5 illustrates a perspective view of a housing and a lens module of a camera module according to an example.

FIG. 6 illustrates a perspective view in which the inside of a camera module according to an example is exposed by removing a cover thereof.

FIG. 7 illustrates a perspective view of two lens barrels of the camera module illustrated in FIG. 6.

FIG. 8 illustrates a top plan view in which the inside of the camera module illustrated in FIG. 6 is exposed by removing a cover thereof.

FIG. 9 illustrates a top plan view in which the inside of a camera module according to an example is exposed by removing a cover thereof.

FIG. 10 illustrates an exploded perspective view of a housing and a folded module of a camera module according to an example.

Throughout the drawings and the detailed description, the same reference numerals refer to the same elements. The drawings may not be to scale, and the relative size, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that would be well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will fully convey the scope of the disclosure to one of ordinary skill in the art.

Herein, it is noted that use of the term “may” with respect to an example or embodiment, e.g., as to what an example or embodiment may include or implement, means that at least one example or embodiment exists in which such a feature is included or implemented while all examples and embodiments are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes illustrated in the drawings may occur. Thus, the examples described herein are not limited to the specific shapes illustrated in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

The drawings may not be to scale, and the relative sizes, proportions, and depiction of elements in the drawings may be exaggerated for clarity, illustration, and convenience.

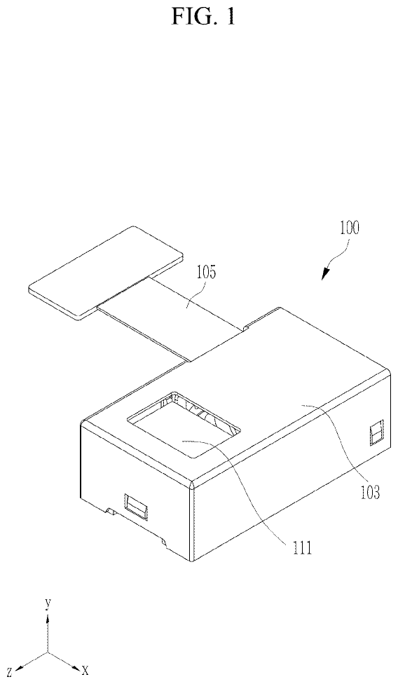

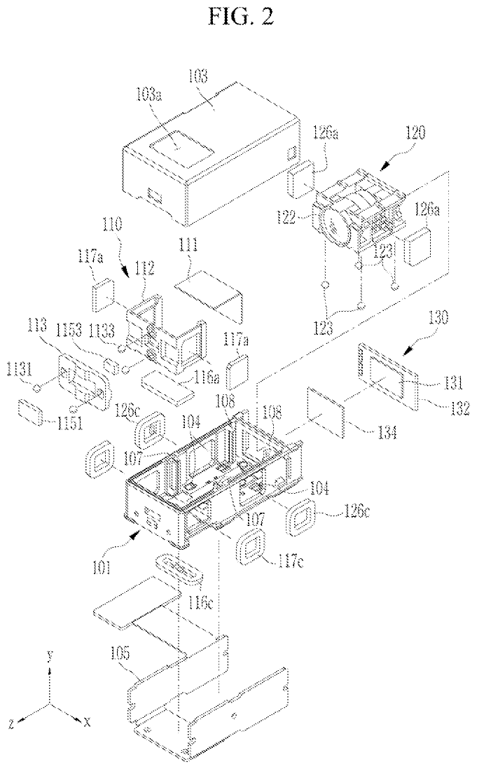

FIG. 1 illustrates a perspective view of a camera module according to an example, and FIG. 2 illustrates a schematically exploded perspective view of the camera module illustrated in FIG. 1.

Referring to FIG. 1 and FIG. 2, a camera module 100 may include a folded module 110, a lens module 120, and an image sensor module 130. The folded module 110 and the lens module 120 are accommodated in an inner space of a housing 101. A cover 103 partially forms an exterior of the camera module 100 while partially surrounding upper and side surfaces of the housing 101.

The folded module 110 may be configured to change a path of light incident from the outside. Light entering the camera through an opening 103a of the cover 103 may be reflected toward the lens module 120 by the folded module 110.

The folded module 110 may include a movable holder 112 mounted with a reflective member 111, and the reflective member 111 may be provided in a form of, for example, a prism or a mirror. The movable holder 112 may be closely supported on an inner wall surface of the housing 101 by attractive force of a pulling yoke 1151 provided on the inner wall surface of the housing 101 and a pulling magnet 1153 provided in the movable holder 112. Between the inner wall surface of the housing 101 and the movable holder 112, a first ball bearing 1131, a rotating plate 113, and a second ball bearing 1133 are provided so that the movable holder 112 is movable inside the housing 101.

The lens module 120 is provided in the inner space of the housing 101 to be movable in an optical axis direction, and includes a lens barrel 122 provided with at least one lens therein. The light reflected from the folded module 110 is refracted while passing through the lens module 120. The light passing through the lens module 120 is incident on an image sensor 131. When the lens module includes a plurality of lenses, the plurality of lenses are arranged in the optical axis direction.

The image sensor module 130 may include the image sensor 131 and a circuit board 132 on which the image sensor 131 is mounted. An image is formed on an image forming surface (or upper surface) of the image sensor 131, and in response to this, the image sensor 131 generates an image signal for the formed image, and the image signal may be transmitted to an external circuit through the circuit board 132. The image sensor module 130 may include an infrared blocking filter 134 that filters infrared rays incident from the lens module 120.

The camera module 100 according to the present embodiment may provide an auto focus (AF) function and an optical image stabilization (01S) function.

The lens module 120 may adjust a focal distance while reciprocating along the optical axis. A focus adjusting driver may be disposed at a side portion of the lens module 120. The lens module 120 may have a focus adjusting magnet 126a (or two focus adjustment magnets 126a) mounted thereon, and a focus adjusting coil 126c (or two focus adjustment coils 126c) may be disposed at a position opposite to the focus adjusting magnet 126a. The lens module 120 may move along the optical axis by electromagnetic interaction between the focus adjusting coil 126c and the focus adjusting magnet 126a. The focus adjusting coil 126c may be mounted on a substrate 105 that is attached to the housing 101, and the housing 101 may have an opening so that the focus adjusting coil 126c and the focus adjusting magnet 126a may face each other.

For smooth driving, ball members 123 may be disposed between the lens module 120 and an inner bottom surface of the housing 101. The lens module 120 and the inner bottom surface of the housing 101 may include guide grooves 104 for partially accommodating the ball members 123. The guide grooves 104 extend in a direction parallel to the optical axis, and a movement direction of the ball members 123 is limited to an extension direction of the guide grooves 104 (that is, the optical axis direction).

By rotating the folded module 110 about an axis perpendicular to the optical axis, the optical image stabilization (01S) function, that is, a shake correction function may, be implemented. That is, the folded module 110 may include a shake correction driver configured to rotate the reflective member 111 with respect to the housing 101 based on an axis perpendicular to the optical axis. The shake correction driver may include a first shake correction driver configured to rotate the reflective member 111 based on a first axis perpendicular to the optical axis, and a second shake correction driver configured to rotate the reflective member 111 based on a second axis that is perpendicular to the optical axis and crosses the first axis. For example, the optical axis may be parallel to a z-axis of FIG. 2, the first axis may be parallel to a y-axis of FIG. 2, and the second axis may be parallel to an x-axis of FIG. 2.

The shake correction driver rotates the reflective member 111 based on the first axis and/or the second axis, so that shaking of the image formed on the image sensor 131 due to the shaking of the camera module 100 may be optically corrected. To this end, the shake correction driver may generate driving force so that the movable holder 112 is rotatable based on two axes.

The shake correction driver includes a plurality of shake correction magnets 116a and 117a and a plurality of shake correction coils 116c and 117c disposed to face the shake correction magnets. When electric power is applied to the plurality of shake correction coils 116c and 117c, by electromagnetic interaction between the plurality of shake correction magnets 116a and 117a and the plurality of shake correction coils 116c and 117c, it is possible to rotate the movable holder 112 equipped with the plurality of shake correction magnets 116a and 117a based on the first axis (y-axis) and the second axis (x-axis).

The shake correction magnets 116a and 117a are mounted on the movable holder 112. For example, one (116a) of the plurality of shake correction magnets 116a and 117a may be mounted on a lower surface of the movable holder 112, and the other (117a) thereof may be mounted on a side surface of the movable holder 112.

The shake correction coils 116c and 117c are mounted on the housing 101. For example, the plurality of shake compensation coils 116c and 117c may be mounted on the housing 101 via the substrate 105. That is, the plurality of shake correction coils 116c and 117c are provided on the substrate 105, and the substrate 105 is mounted on the housing 101. Here, in FIG. 2, the substrate 105 is provided integrally as a whole so that both the coil for the folded module 110 and the coil for the lens module 120 are mounted, but the substrate 105 may be divided into two or more substrates so that the coil for the folded module 110 and the coil for the lens module 120 are mounted respectively.

In the inner space of the housing 101, a space in which the folded module 110 is disposed and a space in which the lens module 120 is disposed may be divided by a first protruding wall 107. That is, based on the first protruding wall 107, the folded module 110 may be provided at the front side, and the lens module 120 may be provided at the rear side. The first protruding wall 107 may have a shape that partially protrudes from both inner walls of the housing 101 to an inner space thereof.

In the inner space of the housing 101, a space in which the lens module 120 is disposed and a space in which the image sensor module 130 is disposed at a rear thereof may be divided by a second protruding wall 108. That is, based on the second protruding wall 108, the lens module 120 may be provided at the front side, and the image sensor module 130 may be provided at the rear side. The second protruding wall 108 may be provided to have a shape that partially protrudes from both inner walls of the housing 101 to an inner space thereof.

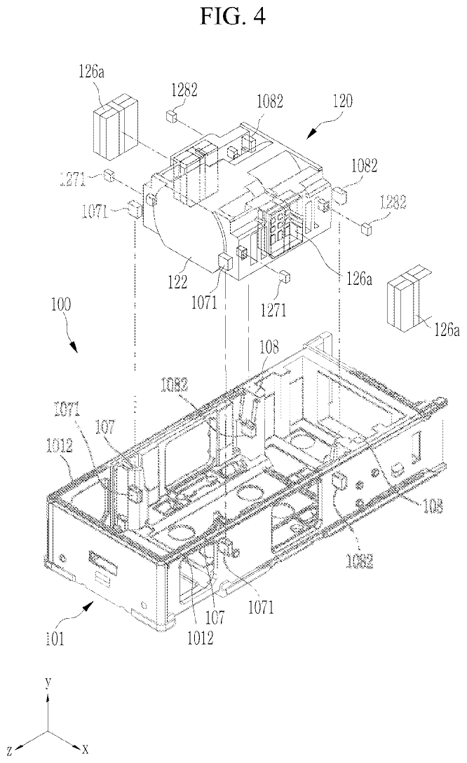

Stationary magnet stopper members 1071 and 1082 (see FIG. 4) may be respectively disposed on the first and second protruding walls 107 and 108 of the housing 101, and moving magnet stopper members 1271 and 1282 (see FIG. 4) may be disposed on the lens module 120. In this case, the stationary magnet stopper members 1071 and 1082 and the moving magnet stopper members 1271 and 1282 may be aligned to face each other in the optical axis direction. The stationary magnet stopper members 1071 and 1082 and the moving magnet stopper members 1271 and 1282 may configure a magnet stopper that generates a repulsive force to each other while their opposite surfaces are magnetized with the same polarity, and thus, when the lens module 120 moves in the optical axis direction, a driving range may be limited by the magnet stopper.

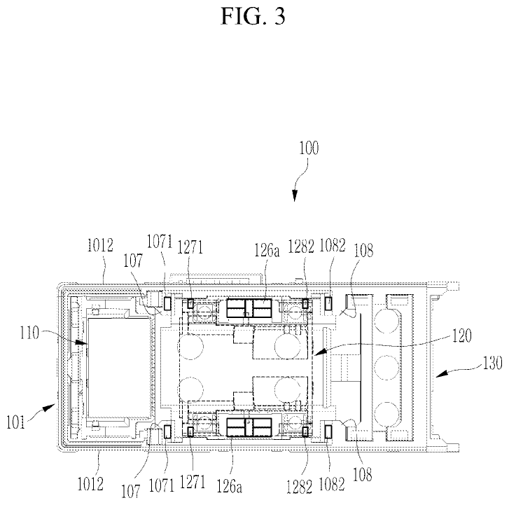

FIG. 3 illustrates a top plan view in which the inside of the camera module illustrated in FIG. 1 is exposed by removing a cover thereof, and FIG. 4 illustrates a perspective view of a housing and a lens module of the camera module illustrated in FIG. 1.

Referring to FIG. 3 and FIG. 4, the camera module 100 may include a magnet stopper disposed to limit the movement of the lens module 120 in the optical axis direction between the lens module 120 and the housing 101. The magnet stopper may include the stationary magnet stopper members 1071 and 1082 disposed in the housing 101 and the moving magnet stopper members 1271 and 1282 disposed in the lens module 120, and the stationary magnet stopper members 1071 and 1082 and the moving magnet stopper members 1271 and 1282 may be aligned to face each other in the optical axis direction.

The stationary magnet stopper members 1071 and 1082 and the moving magnet stopper members 1271 and 1282 may be magnetized with the same polarity on opposite surfaces facing each other to generate a repulsive force that repels them from each other. This repulsive force becomes stronger as the stationary magnet stopper members 1071 and 1082 and the moving magnet stopper members 1271 and 1282 approach each other, and becomes weaker as they move away from each other.

The moving magnet stopper members 1271 and 1282 may be respectively disposed at front and rear ends along the optical axis direction of the lens module 120. In this case, the front end along the optical axis direction may be defined as an end closer to the folded module 110, and the rear end along the optical axis direction may be defined as an end closer to the image sensor module 130.

A pair of moving magnet stopper members 1271 and 1282 may be respectively disposed at the front and rear ends of the lens module 120. That is, a pair of moving magnet stopper members 1271 may be fixed symmetrically at both sides of the lens module 120 with respect to the optical axis at the front end of the lens module 120, and another pair of moving magnet stopper members 1282 may be fixed symmetrically at both sides of the lens module 120 with respect to the optical axis at the rear end of the lens module 120. Accordingly, the moving magnet stopper members 1271 and 1282 may be disposed one by one in the vicinity of four corners of the lens module 120 when viewed in a plan view.

The housing 101 includes a pair of side walls 1012 facing each other and parallel to a light incident axis (the y-axis) and the optical axis (the z-axis), and the lens module 120 may be driven along the optical axis between the pair of side walls 1012 of the housing 101. The lens module 120 may include the lens barrel 122 for fixing and accommodating a plurality of lenses aligned along the optical axis, and focus adjusting magnets 126a fixed to both sides of a mold structure respectively facing the pair of side walls 1012 of the housing 101.

The moving magnet stopper members 1271 and 1282 may be inserted and fixed into grooves formed in the mold structure forming the exterior of the lens module 120. The groove is opened laterally perpendicular to the optical axis so that the moving magnet stopper members 1271 and 1282 may be inserted from a lateral portion thereof. Since the focus adjusting magnet 126a is substantially positioned at a middle of a length along the optical axis direction of the lens module 120, the moving magnet stopper members 1271 and 1282 may be disposed to be spaced apart from each other at the front and rear of the focus adjusting magnet 126a.

The groove formed in the mold structure in order to fix the moving magnet stopper members 1271 and 1282 may be applied to a structure that is opened to one side in addition to the structure that is opened laterally as described above, which is also within the scope of the present examples. For example, the moving magnet stopper member may be inserted and fixed from one side in the optical axis direction into a groove that is opened in the optical axis direction, and it is also possible that the moving magnet stopper member is inserted and fixed from the top into a groove that is opened to a direction perpendicular to the optical axis.

The stationary magnet stopper members 1071 and 1082 may be disposed to be spaced apart from the lens module 120 at the front and rear sides of the lens module 120 in the optical axis direction, respectively. In this case, the front side along the optical axis direction may be defined as a direction closer to the folded module 110, and the rear side along the optical axis direction may be defined as a direction closer to the image sensor module 130.

At least one pair of the stationary magnet stopper members 1071 and 1082 may be symmetrically disposed adjacent to each of the pair of side walls 1012 of the housing 101 with respect to the optical axis. That is, the housing 101 may include the first and second protruding walls 107 and 108 protruding from each of the pair of side walls 1012 toward the inner space thereof, and the stationary magnet stopper members 1071 and 1082 may be fixed to the first and second protruding walls 107 and 108.

Four total first and second protruding walls 107 and 108 may respectively protrude from both side walls 1012 of the housing 101 at the front and rear along the optical axis direction of the lens module 120 accommodated in the housing 101, and the stationary magnet stopper members 1071 and 1082 may be fixed to each of the protruding walls 107 and 108 one by one. In this case, the first and second protruding walls 107 and 108 are provided with grooves opened upward perpendicular to the optical axis, and the fixing magnet stopper members 1071 and 1082 may be inserted into this groove from the top to be fixed.

The groove formed in the first and second protruding walls 107 and 108 in order to fix the stationary magnet stopper members 1071 and 1082 may be applied to a structure that is opened to one side in addition to the structure that is upwardly opened as described above, which is also within the scope of the present invention. For example, the first and second protruding walls 107 and 108 are provided with grooves opened in the optical axis direction, and the stationary magnet stopper member may be inserted and fixed from one side in the optical axis direction into the groove, and it is also possible that the moving magnet stopper member is inserted and fixed from a lateral portion into a groove that is opened laterally perpendicular to the optical axis.

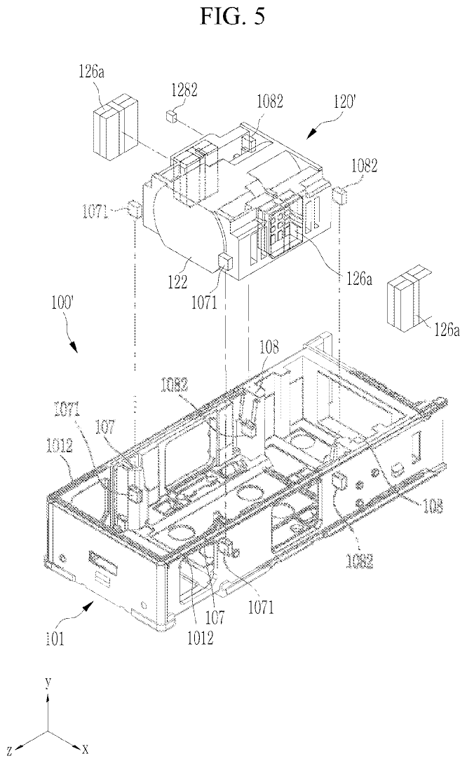

FIG. 5 illustrates a perspective view of a housing and a lens module of a camera module according to another example.

Referring to FIG. 5, a camera module 100′ is configured to have a similar configurations as the camera module 100 shown in FIG. 1, however, there is a difference in a configuration of a magnet stopper.

That is, the housing 101 includes a pair of side walls 1012 facing each other and parallel to a light incident axis (the y-axis) and the optical axis (the z-axis), and a lens module 120′ includes focus adjusting magnets 126a fixed to both sides of the mold structure and respectively facing the pair of side walls 1012 of the housing 101.

In FIG. 5, the magnet stopper includes at least one pair of stationary magnet stopper members 1071 and 1082 symmetrically disposed on the housing 101 with respect to the optical axis, and the stationary magnet stopper members 1071 and 1082 may be fixed to the first and second protruding walls 107 and 108 protruding from the side walls 1012 of the housing 101 toward the inner space. In this case, the stationary magnet stopper members 1071 and 1082 may be disposed to be spaced apart from the lens module 120′ at the front and rear sides of the lens module 120′ in the optical axis direction, respectively.

Four total first and second protruding walls 107 and 108 may respectively protrude from both side walls 1012 of the housing 101 at the front and rear along the optical axis direction of the lens module 120′ accommodated in the housing 101, and the stationary magnet stopper members 1071 and 1082 may be fixed to each of the first and second protruding walls 107 and 108 one by one. In this case, the first and second protruding walls 107 and 108 are provided with upwardly opened grooves, respectively, and the stationary magnet stopper members 1071 and 1082 may be inserted into the grooves from an upper portion to be fixed.

In FIG. 5, the focus adjusting magnet 126a disposed in the lens module 120′ may include a surface opposite to the stationary magnet stopper members 1071 and 1082 in the optical axis direction. Since the stationary magnet stopper members 1071 and 1082 are respectively disposed at the front and rear along the optical axis direction of the focus adjusting magnet 126a, the focus adjusting magnet 126a includes the front and rear facing surfaces. In this case, the opposite surfaces of the stationary magnet stopper members 1071 and 1082 and the focus adjusting magnet 126a may be magnetized with the same polarity to generate a repulsive force that repels each other. Accordingly, the focus adjusting magnet 126a may serve as a moving magnet stopper member.

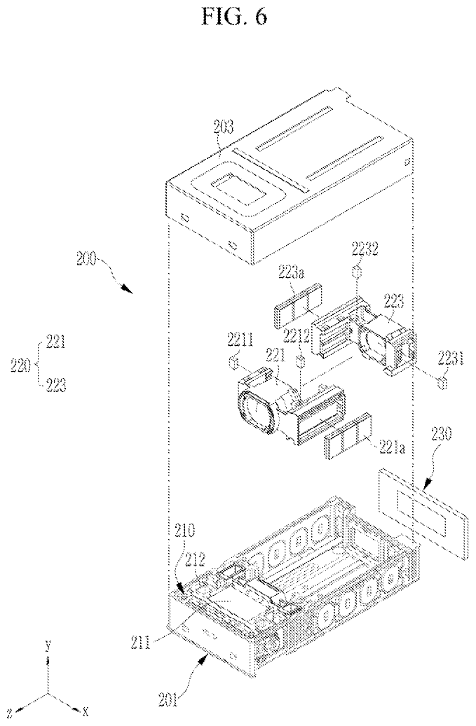

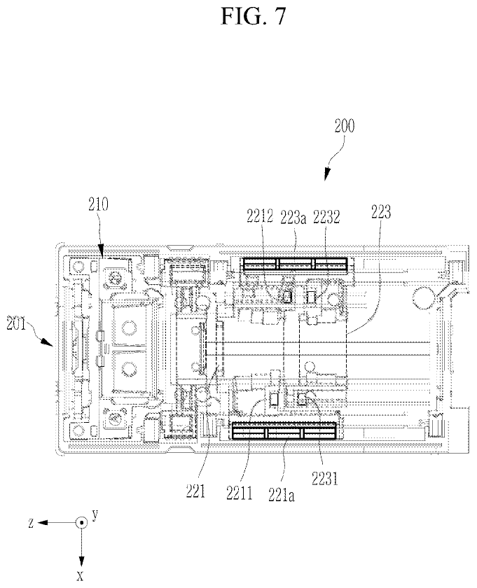

FIG. 6 illustrates an exploded perspective view of a camera module according to another example, and FIG. 7 illustrates a top plan view in which the inside of the camera module illustrated in FIG. 6 is exposed by removing a cover thereof.

Referring to FIG. 6 and FIG. 7, a camera module 200 may include a folded module 210, a lens module 220, and an image sensor module 230. The folded module 110 and the lens module 220 are accommodated in the inner space of a housing 201, and a cover 203 partially surrounds the upper portion and the side surface of the housing 201 to partially configure the exterior of the camera module 200. The folded module 210 includes a reflective member 211 for changing a path by reflecting light incident from the outside, and a movable holder 212 on which the reflective member 211 is mounted and that is disposed in the inner space to be movably supported on the inner wall of the housing 201. Since the folded module 210 and the image sensor module 230 may have the same structure as in the example described with reference to FIG. 1 and FIG. 2, a duplicate detailed description thereof will be omitted.

In the present example, the lens module 220 includes two lens barrels 221 and 223 that are disposed at the rear of the folded module 210 in the inner space of the housing 201 to be respectively movable in the optical axis direction and are provided with a plurality of divided lenses. Accordingly, light reflected from the reflective member 211 may pass through a plurality of lenses aligned in the optical axis direction to be transmitted to the image sensor module 230.

In the camera module 200, the two lens barrels 221 and 223 include a first lens barrel 221 and a second lens barrel 223 that are sequentially arranged to face each other in an optical axis direction, first magnet stopper members 2211 and 2212 are mounted on the first lens barrel 221, and second magnet stopper members 2231 and 2232 are mounted on the second lens barrel 223.

A pair of the first magnet stopper members 2211 and 2212 and a pair of the second magnet stopper members 2231 and 2232 may be disposed at both sides of the lens with respect to the optical axis, respectively. In addition, the first magnet stopper members 2211 and 2212 may be mounted and disposed close to a surface of the first lens barrel 221 facing the second lens barrel 223, and the second magnet stopper members 2231 and 2232 may be disposed and mounted close to a surface of the second lens barrel 223 facing the first lens barrel 221.

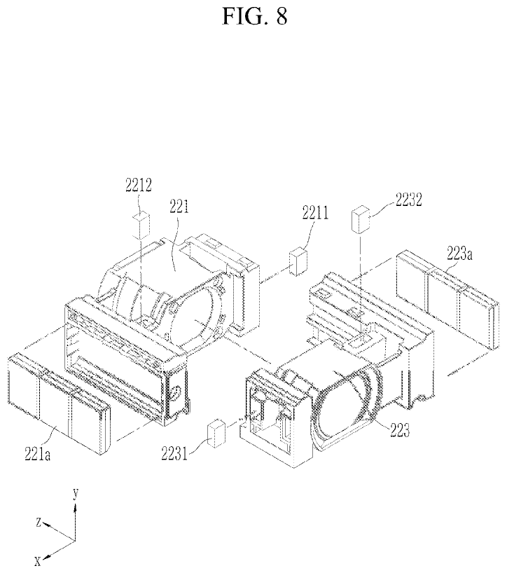

FIG. 8 illustrates a perspective view of two lens barrels of the camera module illustrated in FIG. 6.

Referring to FIG. 8, first magnet stopper members 2211 and 2212 may be inserted and fixed into a groove formed in a mold structure forming an exterior of a first lens barrel 221. In this case, one (2211) of the first magnet stopper members 2211 and 2212 may be inserted from the side into the groove opened laterally in the mold structure, and the other (2212) thereof may be inserted from the top into the groove opened upwardly in the mold structure.

The second magnet stopper members 2231 and 2232 may be inserted and fixed into a groove formed in a mold structure forming an exterior of a second lens barrel 223. In this case, one (2231) of the second magnet stopper members 2231 and 2232 may be inserted from the side into the groove opened laterally in the mold structure, and the other (2232) thereof may be inserted from the top into the groove opened upwardly in the mold structure.

The first magnet stopper members 2211 and 2212 and the second magnet stopper members 2231 and 2232 may be magnetized with the same polarity on opposite surfaces facing each other to generate a repulsive force that repels each other. This repulsive force becomes stronger as the first magnet stopper members 2211 and 2212 and the second magnet stopper members 2231 and 2232 approach each other, and becomes weaker as they move away from each other.

Meanwhile, focus adjusting magnets 221a and 223a may be separately disposed in the first lens barrel 221 and the second lens barrel 223, respectively. That is, the focus adjusting magnet 221a may be disposed at one side of the first lens barrel 221 with respect to the optical axis in a plan view, and the focus adjusting magnet 223a may be disposed at the other side of the second lens barrel 223 with respect to the optical axis in a plan view. Accordingly, the lens module 220 configured by coupling the first lens barrel 221 and the second lens barrel 223 is provided with focus adjusting magnets 221a and 223a at both sides thereof with respect to the optical axis in a plan view.

The focus adjusting magnets 221a and 223a may be disposed outside the first magnet stopper members 2211 and 2212 and the second magnet stopper members 2231 and 2232 based on the optical axis. That is, the focus adjusting magnets 221a and 223a may be disposed to face the inner surface of the side wall of the housing 201 at the outermost sides of both sides of the lens module 220, and the first magnet stopper members 2211 and 2212 and the second magnet stopper members 2231 and 2232 may be provided between the focus adjusting magnets 221a and 223a.

In the present example, it has been described that when two lens barrels are provided, and that a set of magnet stoppers may be formed to alleviate impact and reduce noise generation when contact occurs between them. However, the present disclosure is not limited thereto, and when three or more lens barrels are provided, each magnet stopper is formed between each other, so that two or more sets of magnet stoppers may be included, which also is within the scope of the present disclosure.

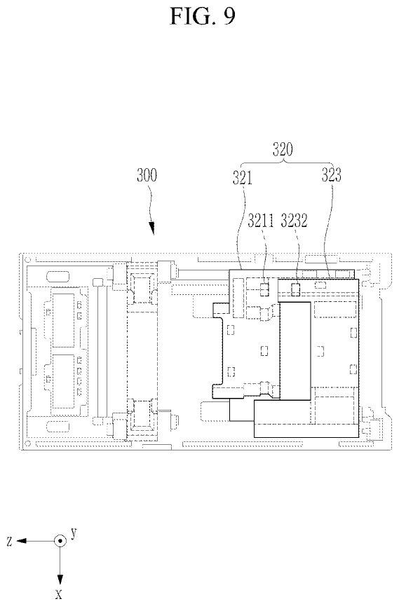

FIG. 9 illustrates a top plan view in which the inside of a camera module according to another example is exposed by removing a cover thereof.

Referring to FIG. 9, in a camera module 300, like the camera module 200 shown in FIG. 7 and FIG. 8, two lens barrels 321 and 323 configure a lens module 320. That is, the lens module 320 includes a third lens barrel 321 and a fourth lens barrel 323 sequentially disposed to face each other in the optical axis direction. In this case, a third magnet stopper member 3211 may be mounted on the third lens barrel 321 and a fourth magnet stopper member 3232 may be mounted on the fourth lens barrel 323 to configure a magnet stopper.

In the present example, the third lens barrel 321 and the fourth lens barrel 323 face each other and the magnet stopper may be formed at a contacting portion of them, and the third magnet stopper member 3211 and the fourth magnet stopper member 3232 may be disposed only at one side of the lens with respect to the optical axis.

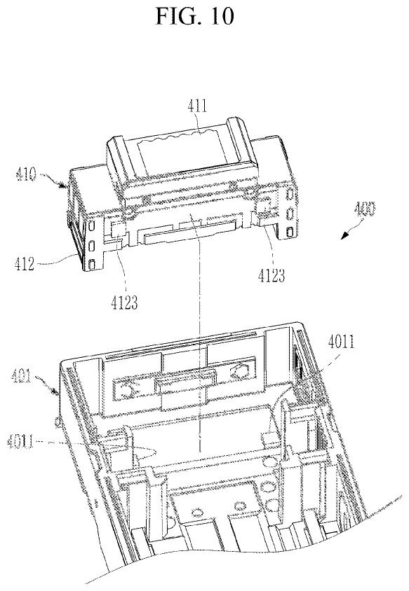

FIG. 10 illustrates an exploded perspective view of a housing and a folded module of a camera module according to another example.

Referring to FIG. 10, a camera module 400 includes a magnet stopper provided in a portion in which a folded module 410 is accommodated in an inner space of a housing 401.

The magnet stopper may include an unmovable magnet stopper member 4011 disposed in the housing 401 and a movable magnet stopper member 4123 disposed in a movable holder 412. In this case, the unmovable magnet stopper member 4011 and the movable magnet stopper member 4123 may be disposed to face each other in the light incident direction to generate a repulsive force.

In addition, a pair of the movable magnet stopper members 4123 may be disposed at both sides of a reflective member 411 with respect to the optical axis in a plan view, and a pair of unmovable magnet stopper members 4011 may be disposed in the housing 401 to respectively face the pair of the unmovable magnet stopper members 4123.

A lens module and an image sensor module may be sequentially disposed at the rear of the folded module 410 in the optical axis direction. In this case, the lens module and the image sensor module may selectively apply the configuration of the camera module described with reference to FIG. 1 to FIG. 9. A detailed description thereof will be omitted in the present example.

As described above, the magnet stopper provided between the folded module and the housing may be provided together with or may be selectively provided separately from the magnet stopper provided between the lens module and the housing or between the plurality of lens barrels of the lens module as described above, and these various combinations of the magnet stopper structures are all within the scope of the present disclosure.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed to have a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a housing defining an inner space;
a movable holder disposed in the inner space and supported on an inner wall of the housing;
a folded module including a reflective member mounted on the movable holder, the reflective member being configured to change a path by reflecting light incident from the outside;
a lens module including a plurality of lenses arranged in an optical axis direction and configured to pass the light reflected from the reflective member;
a lens barrel disposed at a rear side of the folded module in the inner space and configured to move in the optical axis direction; and
a magnet stopper including a stationary magnet stopper member disposed in the housing, and a moving magnet stopper member disposed in the lens module to face the stationary magnet stopper member in the optical axis direction and configured to generate a repulsive force to each other.

2. The camera module of claim 1, wherein
the stationary magnet stopper member includes a stationary magnet stopper member spaced apart from the lens module in front of the lens module in the optical axis direction and a stationary magnet stopper member spaced apart from the lens module in a rear of the lens module in the optical axis direction.

3. The camera module of claim 2, wherein
the moving magnet stopper member includes a moving magnet stopper member disposed at a front end along the optical axis direction of the lens module and a moving magnet stopper member disposed at a rear end along the optical axis direction of the lens module.

4. The camera module of claim 1, wherein
the lens module includes a groove in a mold structure forming an exterior of the lens barrel, and
the moving magnet stopper member is fixed by being inserted into the groove.

5. The camera module of claim 1, wherein
the housing includes a pair of side walls that are parallel to the light incident direction and the optical axis and face each other, and
the stationary magnet stopper member includes at least one first pair of stationary magnet stopper members disposed to be respectively adjacent to the pair of side walls and symmetrical based on the optical axis.

6. The camera module of claim 5, further comprising
a protruding wall that protrudes from the pair of side walls of the housing toward the inner space,
wherein the stationary magnet stopper member is fixed to the protruding wall.

7. The camera module of claim 6, wherein
the protruding wall includes a groove, and
the stationary magnet stopper member is fixed by being inserted into the groove.

8. The camera module of claim 5, wherein
the at least one pair of the stationary magnet stopper members are spaced apart from the lens module in front of the lens module in the optical axis direction, and at least one second pair of the stationary magnet stopper members are spaced apart from the lens module in rear of the lens module in the optical axis direction.

9. The camera module of claim 8, wherein
the moving magnet stopper member includes a first pair of moving magnet stopper members disposed at a front end along the optical axis direction of the lens module and a second pair of moving magnet stopper members disposed at a front end along the optical axis direction of the lens module.

10. The camera module of claim 9, wherein
each of the first and second pairs of moving magnet stopper members includes moving magnet stopper members fixed to the lens module and disposed at both sides of the lens module to be symmetrical based on the optical axis.

11. The camera module of claim 1, wherein
the housing includes a pair of side walls that are parallel to the light incident direction and the optical axis and face each other,
the lens module includes a focus adjusting magnet mounted to face the side wall, and
the moving magnet stopper member is the focus adjusting magnet.

12. The camera module of claim 11, wherein
the stationary magnet stopper member includes a stationary magnet stopper member spaced apart from the lens module in front of the lens module in the optical axis direction and a stationary magnet stopper member spaced apart from the lens module in a rear of the lens module in the optical axis direction, and the stationary magnet stopper members face the focus adjusting magnet in the optical axis direction.

13. A camera module comprising:
a housing defining an inner space;
a folded module including a reflective member that changes a path by reflecting light incident from the outside, and a movable holder on which the reflective member is mounted and that is disposed in the inner space and supported on an inner wall of the housing to be movable;
a lens module including a plurality of lenses aligned in an optical axis direction to pass light reflected from the reflective member, and at least two lens barrels are disposed at a rear side of the folded module in the inner space and configured to be movable in the optical axis direction and in which the plurality of lenses are divided and provided; and
a first magnet stopper member disposed in one of the at least two lens barrels, and a second magnet stopper member disposed in the other one of the at least two lens barrels to face the first magnet stopper member in the optical axis direction and configured to generate a repulsive force to each other.

14. The camera module of claim 13, wherein
the at least two lens barrels include a first lens barrel and a second lens barrel that are sequentially disposed to face each other in the optical axis direction and in which the first magnet stopper member and the second magnet stopper member are mounted, respectively, and
the first magnet stopper member is disposed and mounted close to a surface of the first lens barrel facing the second lens barrel, and the second magnet stopper member is disposed and mounted close to a surface of the second lens barrel facing the first lens barrel.

15. The camera module of claim 14, wherein
a pair of the first magnet stopper members and a pair of the second magnet stopper members are respectively disposed at both sides of the lens barrel based on the optical axis.

16. A camera module comprising:
a housing defining an inner space;
a folded module including a reflective member that changes a path by reflecting light incident from the outside, and a movable holder on which the reflective member is mounted and that is disposed in the inner space and supported on an inner wall of the housing to be movable;
a lens module including a plurality of lenses arranged in an optical axis direction to pass the light reflected from the reflective member, and a lens barrel disposed at a rear side of the folded module in the inner space and configured to move in the optical axis direction; and
a magnet stopper including an unmovable magnet stopper member disposed in the housing, and a movable magnet stopper member disposed in the movable holder to face the unmovable magnet stopper member in the light incident direction and configured to generate a repulsive force to each other.

17. The camera module of claim 16, wherein
a pair of the movable magnet stopper members are disposed at both sides of the reflective member based on the optical axis.

18. The camera module of claim 17, wherein
a pair of the unmovable magnet stopper members are disposed in the housing to respectively face the movable magnet stopper members.
